(19) United States
(12) Patent Application Publication
(10) Pub. No.: US 2013/0087633 A1
(43) Pub. Date: Apr. 11, 2013

(54) COLD SPRAY GUN

(71) Applicant: Hirotaka Fukanuma, Tokyo (JP)

(72) Inventor: Hirotaka Fukanuma, Tokyo (JP)

(21) Appl. No.: 13/270,450

(22) Filed: Oct. 11, 2011

(51) Int. Cl. B05B 7/00

(52) U.S. Cl. 239/128

(57) ABSTRACT

An improved cold spray gun apparatus and system, which prevents nozzle clogging and erosion of the nozzle material. The nozzle can be configured as a non-monolithic assembly that includes a passageway for spraying powder material. The passageway can include a converging section and a diverging section. Such an arrangement is, in part, a result of a selection of specific nozzle material for the diverging section and a cooling system. The improved cold spray gun enables applying coatings at high spray parameters (e.g., pressure up to 5 MPa, temperature up to and in excess of 1000° C.), and can achieve high quality coatings, deposition efficiency, density, adhesion and cohesion, and other advantages. Additionally, the disclosed apparatus makes it possible to spray a wide range of powder materials in commercial applications without nozzle clogging or nozzle erosion during continuous operation.

### TECHNICAL FIELD

The disclosed embodiments relate to an improved cold spray gun design for use in a cold spray system for depositing metals, alloys, or composites as coatings onto a work piece.

### BACKGROUND

Cold gas dynamic spraying (“cold spray”) is a process of applying coatings by exposing a metallic or dielectric substrate to a high velocity (e.g., 300 to 1200 m/s) jet of small (e.g. 1 to 100 micron) particles accelerated by a supersonic jet of compressed gas. In this process powder particles are injected into a de-Laval type nozzle where they are accelerated to high velocities by a supersonic gas stream. Upon impingement on a substrate, the powder particles are plastically deformed and form a coating through their bonding to the substrate and to one another.

A cold spray system of this type is described in U.S. Pat. No. 5,302,414 to Alkhimov et al., which is herein incorporated by reference. With this spray process, metallic coatings can be deposited with a high deposition rate, a low porosity, and good coating—substrate adhesion. The process is based on the combination of particle temperature, velocity, and size that allows particles in solid state to be sprayed as a coating. As a consequence, the deleterious effects of high-temperature oxidation, evaporation, melting, crystallization, residual stresses, gas release, and other common problems associated with traditional thermal spray methods are minimized or eliminated.

The main factors influencing accelerating behavior properties of powder particles with respect to plastic deformation of particles on substrate and coating properties are the nozzle expansion ratio, accelerating gas type, operating pressure and temperature, powder particle size, and morphology. It is well known that the higher operating temperature leads to higher quality coating. To provide high quality coating properties (e.g. deposition efficiency, adhesion, density, etc.) for many hard powder materials like Ti-6Al-4V, nickel, stainless steel, tantalum, and others, it is necessary to increase spray temperature up to at least 1000° C.

However, while spraying many powder materials it is difficult to provide a necessary (optimal) operating temperature because of the effect on nozzle dogging. The heated particles can adhere to the inside walls of the nozzle and the nozzle can become clogged in several minutes, depending on operating temperature and material being sprayed.

Due to these limitations, conventional technologies related to the manufacture of cold spray guns currently fail to provide a cold spray gun assembly that is commercially feasible. For example, during the deposition of certain materials (e.g. aluminum) the nozzle portion of the spray gun can quickly become clogged with metallic powder causing system failure. It is then necessary to stop the operation and remove the damaged nozzle to remove the obstruction or replace the nozzle entirely. The clogging generally occurs within a matter of several minutes, whereas a continuous work flow, of at least hours, is needed to commercialize this technology. Moreover, in a commercial gun assembly, the internal surfaces of the nozzle are subject to wear from the typically hard powder material. Another important requirement for commercialization is a low erosion rate of the nozzle material that provides an extended lifetime for the nozzle. Thus, two processes must be taken into account in development of a nozzle for spraying a given powder: the process of nozzle clogging and the process of erosion of the nozzle material.

One possible solution to nozzle clogging is described in U.S. Pat. No. 7,543,764 to Haynes et al. Haynes et al. propose forming at least the diverging section of a nozzle from polybenzimidazole. However, this configuration has limited practical use because of the high erosion rate of the nozzle material and the low temperature tolerance of this material. Polybenzimidazole can only withstand temperatures of up to 316° C. according to the material property data sheet obtained from MatWeb.com. Consequently, the apparatus of Haynes et al. can only be used for spraying relatively soft powder materials such as aluminum, tin, silver, etc., which do not require high operating temperatures and do not cause high rates of erosion. Nozzles made of other plastic material can also prevent nozzle clogging, however, their application is not commercially practical because of the high rate of erosion.

U.S. Patent Application Publication No. 20100181391 to Gartner et al. describes a cold spray nozzle whose inner walls are at least partially coated for spraying at temperatures up to 800° C. The coating is comprised of a material that is minimally reactive with the material to be sprayed. The nozzle is made of two half shells that are coated separately and then connected. The thin coating thickness (e.g. 2-100 microns for chromium) leads to frequent coating repair or replacement due to high rates of erosion during spray of hard powder materials. The disclosed apparatus is only effective at temperatures up to 800° C. and only if the coating is very hard with good adhesion to the nozzle material and has a very smooth surface. These requirements are difficult to achieve in practice.

Another method to prevent clogging is described in U.S. Patent Application Publication No. 20070074656 A1 to Zhao et al. The disclosed powder injector comprises a powder feed tube and a sleeve wherein the powder feed tube is installed within the sleeve and having an air gap between the two in order to reduce the feed tube wall temperature. This reduces the tendency of the particles to adhere to the walls of the tube. However, this method cannot provide adequate cooling to the nozzle of the gun and is only intended to prevent clogging of the powder injector, not the nozzle of the gun.

U.S. Patent Application Publication No. 20100136242 to Kay et al. describes a cold spray gun that includes a one-piece polymer nozzle and cooling system. The nozzle can be formed from a creep resistant polymer such as Celezel® or Vespel®. As previously discussed, the lifetime of a nozzle made of such a polymer is subject to high erosion rates, especially in the throat area, when spraying relatively hard materials like super alloys at temperatures of 700-800° C. In addition, the cooling system disclosed cannot significantly reduce the erosion rate of the one-piece polymer nozzle. The result is an apparatus that can spray a limited variety of materials without clogging for a short amount of time, but cannot provide continuous spray of a wide variety of materials.

Therefore, a need exists for an improved spray gun that can provide a continuous spray of a wide spectrum of powdered materials for extended periods at high temperatures, up to and in excess of 1000° C., without clogging of the nozzle and while resisting erosion.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

A key requirement for industrial cold spray equipment is to achieve continuous operation at required spray temperatures and pressures. The present cold spray guns cannot meet this requirement because of the limited life of the nozzles due to clogging and/or erosion of the nozzle material. Current technologies are also limited to operating temperatures of less than 800° C., whereas high quality coatings for many hard powder materials require temperatures up to and in excess of 1000° C.

It is one aspect of the disclosed embodiments to make available for commercial applications a cold spray gun having a nozzle that can achieve continuous spray, for a desired duration (e.g. several hours), of a wide range of materials at high operating temperatures.

To achieve these and other advantages, a cold spray nozzle and varying embodiments thereof are disclosed. Such a nozzle generally includes a passageway for spraying powders consisting of a converging section and a diverging section. The converging section can be configured from a hard, erosion and wear resistant metal alloy or ceramics, and the diverging section can be formed from material that resists nozzle clogging while also resisting erosion. The spray gun can further incorporate an improved cooling system.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a schematic view of a cold spraying system including a cold spray gun assembly, in accordance with the disclosed embodiments;

FIG. 2 illustrates a cross-sectional view of a cold spray gun which can be used with the cold spray gun system, in accordance with the disclosed embodiments;

FIGS. 3a-3c illustrate nozzle sections and assemblies thereof, in accordance with the disclosed embodiments;

FIG. 4 illustrates a cold spray gun including a cooling system, which can be implemented in accordance with the disclosed embodiments;

FIG. 5 illustrates a cross-sectional view of a cold spray gun having a cooling system, in accordance with one embodiment; and

FIG. 6 illustrates a cross-sectional view of a cold spray gun having a cooling system, in accordance with another embodiment.

### DETAILED DESCRIPTION

It is to be understood by persons of ordinary skill in the art that the following descriptions are provided for purposes of illustration and not for limitation. An artisan understands there are many variations that lie within the spirit of the disclosed embodiments and the scope of the appended claims. Unnecessary detail of known functions and operations may be omitted from the current description so as not to obscure the disclosed embodiments.

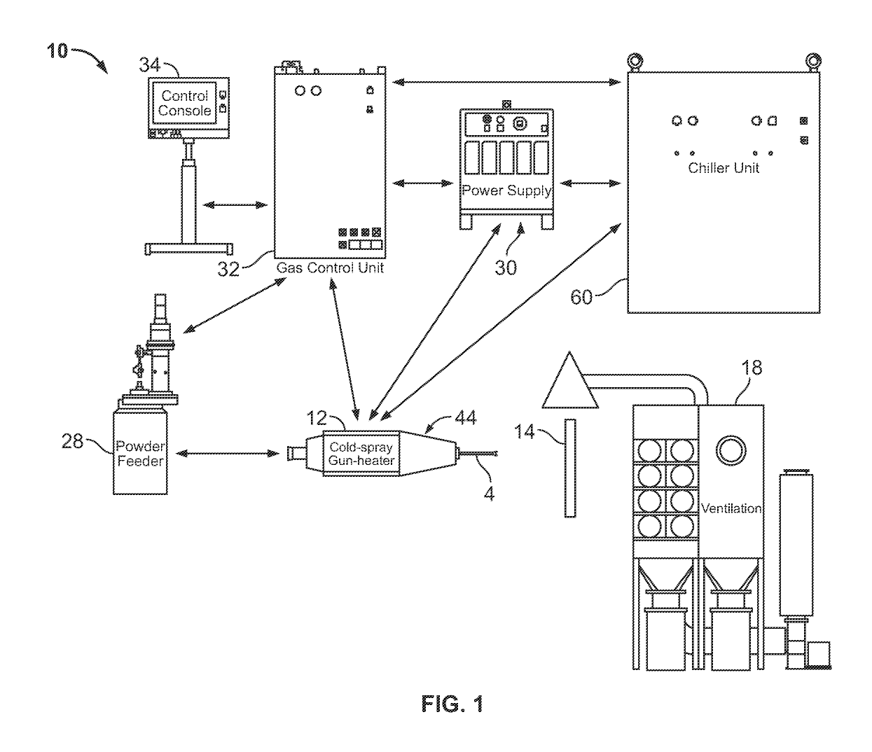

FIG. 1 illustrates a system 10 for cold spray coating, in accordance with the disclosed embodiments. As depicted in FIG. 1, system 10 can include a cold spray gun-heater unit 12 as part of a gun assembly 44 for delivering a powder material to a substrate 14. The schematic arrangement depicted in FIG. 1 provides a cabinet with a ventilation system 18 for depositing the powder material onto the substrate 14 in a controlled environment.

A gas control unit 32 provides the carrier gas, typically Helium and/or Nitrogen, to the gun assembly 44 and powder supply unit 28. The gas control unit 32 is programmable and may supply other carrier gasses if desired. A power supply unit 30 provides power to a heater assembled in the cold spray gun-heater unit 12, which is regulated by the gas control unit 32 and heats the carrier gas to a desired temperature prior to entering gun assembly 44. A powder supply 28 provides a powder material to the gun assembly 44 using the carrier gas supplied from the gas control unit 32. The gas control unit 32 regulates the supply of the material to the gun assembly 44 in response to the parameters input at a control console 34 having a user interface. The system 10 shown in FIG. 1 is exemplary in nature and may include additional components or may omit certain illustrated components. Note that in FIGS. 1-6 herein, identical or similar parts or elements are generally indicated by identical reference numerals.

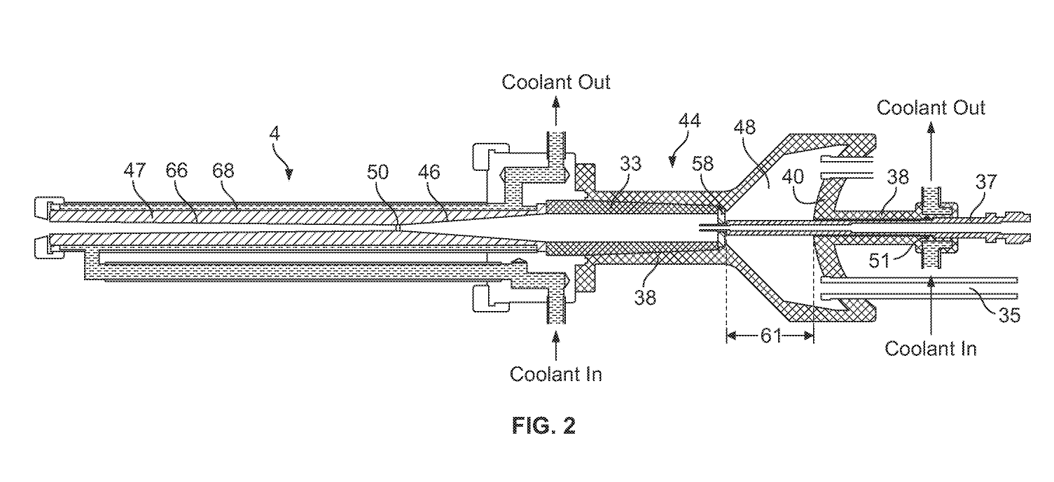

FIG. 2 illustrates a gun assembly 44 in accordance with the disclosed embodiments. As shown in FIG. 2, a mixing chamber 48 receives heated carrier gas through a gas supply conduit 35. A powder carrier tube 37 can be secured to the chamber 48 using a threaded connection. The treaded connection includes at least one O-ring 51. A body 38, which houses a nozzle 4, can be secured to the mixing chamber 48. A sleeve 33 includes a tapered surface 58 at its end. The tapered surface 58 provides a transition for the carrier gas entering the converging section 46. The body 38 includes a powder feeder housing 40 that permits powder feeder tube to be removably inserted into the body 38. The area between the taper surface 58 and powder feeder housing 40 comprises a taper clearance 61.

In cold spray technologies, it understood that nozzle expansion ratio, accelerating gas type, operating pressure, operating temperature, powder particle size, and morphology are the main factors influencing acceleration behavior properties of powder particles related to plastic deformation of particles on substrate. A higher operating temperature can result in higher levels of plastic deformation. Thus, greater plastic deformation of particles leads to a higher quality coating. To meet the demands of industrial high quality coatings, as depicted in FIG. 2, the nozzle 4 can be configured from materials specific to preventing nozzle clogging. Alternate embodiments of the cold spray gun 44 can incorporate particular coolant system designs, which can enable operation parameters up to and in excess of 1000° C. and 5 MPa.

Numerous nozzle designs and materials have been proposed throughout the years, but almost none of them have demonstrated the requisite properties for successful commercialization. Depending on the properties of the powder material that is sprayed, the quality of the nozzle 4 with regard to continuous performance can vary based on the materials, which it is made from. Some spray materials including, for example, Al, Sn, Zn, ZnAl, have a higher tendency to adhere to the walls of the nozzle 4. To achieve continuous spray of these materials requires a particular type of nozzle 4 formed in two sections from materials having erosion resistant and heat resistant properties.

Clogging of the passageway in the nozzle 4 is prevented by forming diverging section 47 of the nozzle 4 from a non-metallic wear resistant material such as, for example, a polyimide shape based on Biphenyl tetracarboxilic dianhydride (BPDA). This material is available commercially under the trade name UPIMOL SA 201. BPDA is a polyimide having Rockwell E hardness of 85 and has excellent anti-erosion properties. This material can be compression molded to any required dimensions. It can also be easily machined from bar stock to very fine tolerances. Furthermore, BPDA is an excellent high-resistant polyimide shape, its heat distortion temperature is 486° C. which allows a nozzle formed from BPDA to be used in cold spray operations during which temperatures may exceed 800° C. Additionally, the converging section 46 of the nozzle 4 can be formed from hard wear resistant materials such as metal alloys, cermets or ceramics including, but not limited to, UNS 530403 Stainless Steel or Tungsten Carbide Cobalt (WC-CO).

An erosion test was performed using a nozzle 4 comprising diverging section 47 formed from BPDA and converging section 46 formed from Stainless Steel. The jet conditions were 580 psi at 385° C. using Helium as the carrier gas and spraying H-50 aluminum, which is a product name for 99.7% pure aluminum powder provided by Valimet Inc., at a feed rate 250 grams per minute. There was no observable change in nozzle passage contour after 40 minutes of spraying operation.

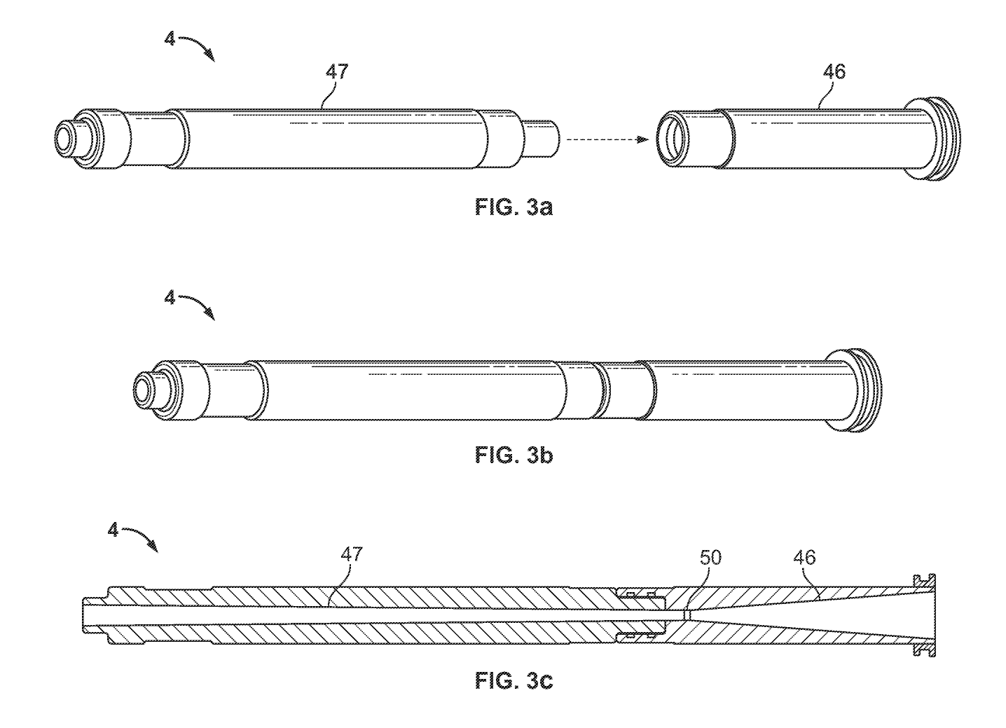

The sections of the nozzle 4 and their assembly are shown in FIGS. 3a-3c. It is inevitable that the inner surfaces of nozzle 4 are subject to wear as the powder material abrades its surfaces during use, Depending upon the powder material properties and desired operation parameters, erosion mainly occurs at the throat 50 of the nozzle 4 and the divergent section 47 where the powder particles reach high velocities. To address this issue, the nozzle 4 is assembled from two individual sections, converging 46 and diverging 47 sections that are connected by a throat 50. Diverging portion 47 and the converging portion 46 are connected and secured to form nozzle 4. Such a non-monolithic configuration of the nozzle 4 is economically useful and allows for changing only the divergent section 47 of the nozzle 4, as opposed to having to replace the entire nozzle.

Furthermore, some materials, including Ti, Ti 6Al-4V, Inconel®, Nb, Ni, Stainless Steel, MCrAlY, Ta, etc., need to be sprayed at high operation temperatures, up to and in excess of 1000° C., to form high quality, dense coatings. To be able to operate at temperatures higher than 800° C. without dogging of the passageway in the nozzle 4, the divergent portion 47 can be formed from Low Expansion Glass or Silicon Nitrite. Low Expansion Glass has extremely low coefficient of thermal expansion, which accounts for its remarkable ability to undergo large, rapid temperature changes without cracking. In addition to its high temperature stability, its corrosion resistance is unique from other low expansion materials in that it is a glass not a glass ceramic, Clogging of the passageway in the nozzle 4 can also be prevented by forming the diverging section 47 from Silicon Nitride (Si3N4) which is a hard ceramic having high strength over a broad temperature range, moderate thermal conductivity, low coefficient of thermal expansion, moderately high elastic modulus, and unusually high fracture toughness for a ceramic. This combination of properties leads to excellent thermal shock resistance, ability to withstand high structural loads to high temperature, and superior wear resistance.

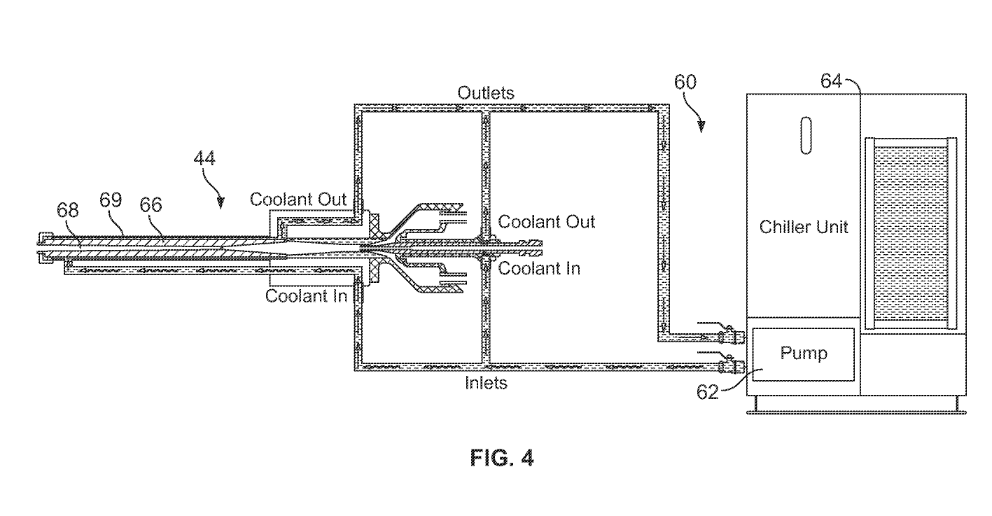

A cold spray gun 44 having a cooling system 60 is shown in FIG. 4. In addition to the material used to form a nozzle 4, the cooling arrangement within the cold spray gun 44 is of great importance in achieving high operation temperatures while reducing erosion. In general, applying a cooling effect to the wall of the nozzle 4 and powder feeder tube 37 or pre-chamber 45 will reduce the temperature of the inner walls of the nozzle passageway and, as a consequence, reduce the effect of particle adhesion to the inner wall of the nozzle 4 and powder feeder tube 37 or pre-chamber 45. Providing cooling will also reduce erosion of the nozzle 4 inner wall because erosion rates are typically lower at lower temperatures compared to higher temperatures. A pump 62 within a chiller unit 64 supplies coolant and provides circulation of the coolant through the coding system 60. This provides reduced median temperatures of both inner 66 and outer 68 walls of the nozzle. As a result, particles can travel at high velocities without adhering to the walls of the nozzle and without significantly affecting the particle velocity distributions, which is a very important parameter in cold spraying in order to form a high quality coating. The water cooling system 60 in the cold spray gun 44 allows for spraying of many different materials at operation temperatures up to and in excess of 1000° C.

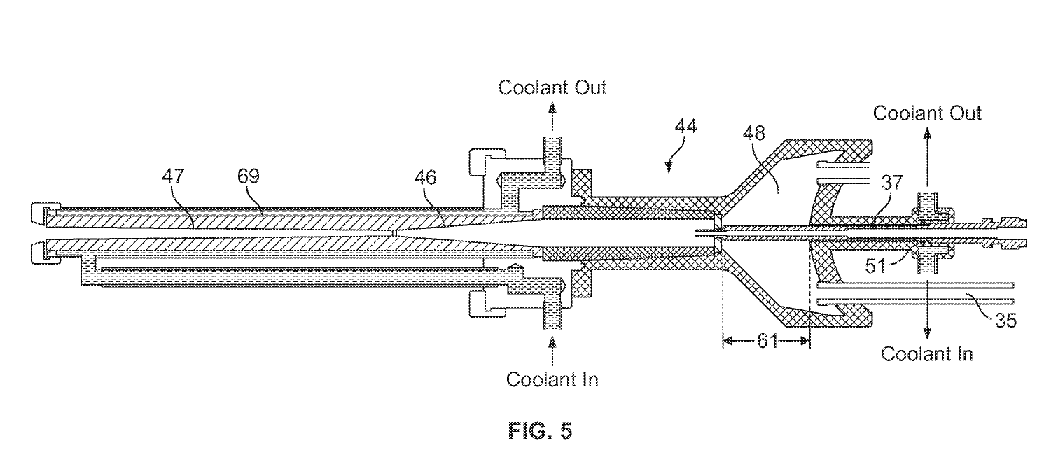

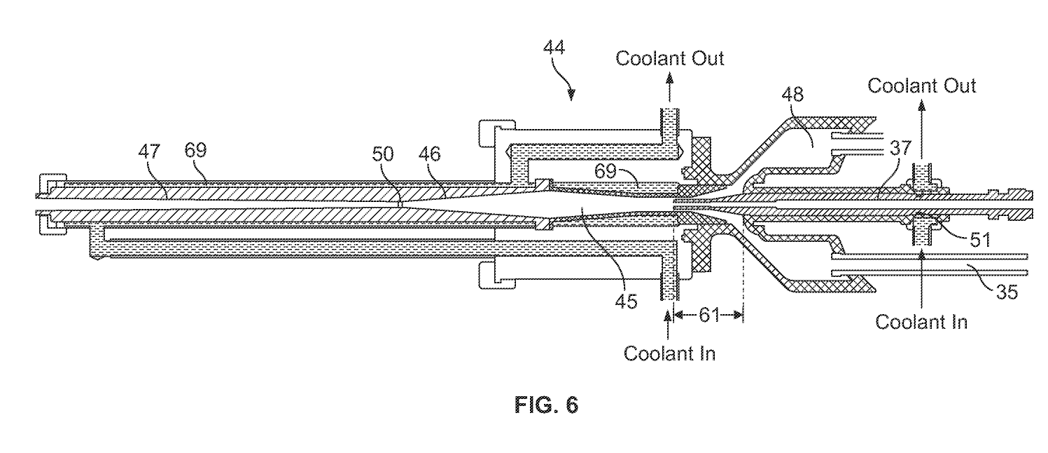

As illustrated in FIGS. 5 and 6, two individual cold spray gun 44 designs are disclosed for spraying materials having different properties. A cold spray gun 44 having a first embodiment of a cooling system 60 is shown in FIG. 5. This cold spray gun assembly 44 includes coolant chambers 69. One of the coolant chambers 69 surrounds the nozzle 4 to allow circulation of coolant in order to cool both converging 46 and diverging 47 portions of the nozzle 4. The cooling system 60 also includes a coolant chamber 69 to allow cooling of the gas seal O-ring 51 where the powder feeder tube 37 meets the mixing chamber 48 in order to prevent damage to the o-ring 51.

Spraying of soft powder materials easily leads to a clogging at powder feeder tube 37 and converging section 46, as well as diverging section 47 of nozzle 4 even while they are being sprayed at relatively low operating temperatures. In order to spray soft materials including Al, Zn, Sn, ZnAl, without experiencing clogging, a cold spray gun assembly 44 having an alternate embodiment of a cooling system 60 is shown in FIG. 6. The cooling system 60 of this alternate embodiment can be configured to include a coolant chamber 69, which provides cooling of the pre-chamber 45. The cooling system also provides cooling for nozzle 4 and powder feeder tube 37 in order to avoid clogging of powder feeder tube 37. Such an alternate embodiment can provide a shortened taper clearance 61 from that of the embodiment described earlier in order to minimize exposure of the powder feeder tube 37 within the chamber 48 and also to maintain the temperature of tube 37 at a level that prevents adhesion of the particles to the inner walls of the powder feeder tube 37.

Such embodiments can allow for spraying of different powdered material at required (optimal) parameters without nozzle clogging and with minimal erosion. For example, a nozzle made of UPIMOL and a cooling system according to the alternate embodiment described above is optimal for spraying relatively soft powders such as aluminum, zinc, etc., while a nozzle made of low expansion glass or silicon nitrite is best suited for spraying hard powders requiring high temperatures such as Inconel®, niobium, stainless steel, MCrAlY, Tantalum, etc. Nozzle designs such as these allow for an increase in spraying temperature from 800° C. to over 1000° C.

This increase in spraying temperature provides significant improvements in various coating properties for a variety of materials. For example, the increase in spraying temperature can reduce the porosity of the resulting coating from approximately 2.2% to 1.2% for stainless steel coatings in experiments using a powder product manufactured by Praxair® labeled FE-101 having an average particle size of 33.9 μm. Porosity was reduced from 1% to 0.7% for titanium coatings in experiments using a powder product manufactured by OSAKA Titanium Technologies labeled TILOP-45 having an average particle size of 28.4 μm. At the same time, deposition efficiency is also increased from 82% to 98% for stainless steel and 90% to 97% for titanium. For some powder materials, this effect is even stronger. For Inconel® 685, the deposition efficiency was increased from 38% at 800° C. to 70% at 1000° C.

Based on the foregoing, it can be appreciated that various embodiments, preferred and alternative, are disclosed herein. For example, in one embodiment, a cold spray gun apparatus for use in the application of a powder material can be disclosed. Such an apparatus can include a nozzle comprising a converging section and a diverging section, wherein the diverging section is formed from a non-metallic wear resistant material and the converging section is formed from a wear resistant material.

In another embodiment, the diverging section can be formed from one or more of the following: BPDA, Low Expansion Glass, or Silicon Nitride. In still another embodiment, the converging section can be formed from one or more of the following: stainless steel, tungsten carbide cobalt, cermets or ceramic. In yet another embodiment, the diverging section can be formed from one or more of the following: BPDA, low expansion glass, or silicon nitride; and the converging section can be formed from one or more of the following: stainless steel, tungsten carbide cobalt, cermets or ceramic.

In another embodiment, a cooling system can be implemented, which provides cooling to the diverging section and the converging section. In still another embodiment, a cooling system can be implemented, which provides cooling to a powder feeder tube. In yet another embodiment, a cooling system can provide cooling to the diverging section and the converging section; and a cooling system can provide cooling to a powder feeder tube. In general, such an apparatus is capable of being operated at temperatures of approximately 1000° C.

In another embodiment, a cold spray system can be implemented, which provides a cold spray gun having a nozzle wherein the nozzle comprises a converging section formed from a wear resistant material and a diverging section formed from non-metallic wear resistant material, the cold spray gun further includes a cooling system. In another embodiment of such a system, the diverging section can be formed from one or more of the following: BPDA, low expansion glass, or silicon nitride. In still another embodiment of such a system, the converging section can be formed from one or more the following: stainless steel, tungsten carbide cobalt, cermets or ceramic. In yet another embodiment of such a system, the diverging section can be formed from one or more of the following: BPDA, low expansion glass or silicon nitride; and the converging section can be formed from one or more of the following: stainless steel, tungsten carbide cobalt, cermets or ceramic. In another embodiment of such a system, the cooling system can provide cooling to a powder feeder tube. In yet another embodiment of such a system, the cooling system can provide cooling to the diverging section and the converging section. In yet other embodiments of such a system, the cooling system can be configured to provide cooling to a powder feeder tube. In still a preferred embodiment, such a system is capable of being operated at temperatures of approximately at least 1000° C.

In yet another embodiment, a cold spray nozzle apparatus can be provided, which includes a converging section and a diverging section wherein the diverging section is formed from a non-metallic wear resistant material and the converging section is formed from a wear resistant material. In another embodiment of such an apparatus, the diverging section can be formed from BPDA, low expansion glass, or silicon nitride and the converging section can be formed from, for example, stainless steel, tungsten carbide cobalt, cermets or ceramic. In yet another embodiment of such an apparatus, a cooling system can provide cooling to the diverging section, the converging section, and a powder feeder tube.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A cold spray gun apparatus for use in application of powder material, said apparatus comprising:
a nozzle comprising a converging section removably connected to a diverging section, wherein said diverging section is formed from Biphenyl tetracarboxilic dianhydride (BPDA), low expansion glass, or silicon nitride and said converging section is formed from metal alloy, cermets or ceramic.

2-4. (canceled)

5. The apparatus of claim 1 further comprising a cooling system that provides cooling to said diverging section and said converging section.

6. The apparatus of claim 1 further comprising a cooling system through which coolant is circulated and which is configured to provide cooling to a powder feeder tube.

7. The apparatus of claim 1 further comprising:
a cooling system that through which coolant is circulated and which is configured to provide cooling to said diverging section, said converging section and a powder feeder tube.

8. The apparatus of claim 1 wherein said cold spray gun is configured to operate at temperatures of approximately 1000° C.

9. A cold spray system, comprising:
a cold spray gun having a nozzle wherein said nozzle comprises a converging section formed from metal alloy, cermets or ceramic removably connected to a diverging section formed from BPDA, low expansion glass, or silicon nitride, said cold spray gun further includes a cooling system.

10-12. (canceled)

13. The system of claim 9 wherein said cooling system is configured to circulate coolant in order to provide cooling to a powder feeder tube.

14. The system of claim 9 wherein said cooling system provides cooling to said diverging section and said converging section.

15. The system of claim 14 wherein said cooling system is configured to provide cooling to a powder feeder tube.

16. The system of claim 9 wherein said cold spray gun is configured to operate at temperatures of approximately 1000° C.

17. A cold spray nozzle apparatus, comprising:
a converging section removably connected to a diverging section wherein said diverging section is formed from BPDA, low expansion glass, or silicon nitride and said converging section is formed from metal alloy, cermets or ceramic.

18. (canceled)

19. The apparatus of claim 17 further comprising a cooling system through which coolant is circulated and which is configured to provide cooling to said diverging section, said converging section and a powder feeder tube.

20. The apparatus of claim 17 wherein said cold spray nozzle is configured to operate at temperatures of approximately 1000° C.
